(19) United States
(12) Patent Application Publication
(10) Pub. No.: US 2012/0282442 A1
(43) Pub. Date: Nov. 8, 2012

(54) Mold Manufacture Method and Mold Formed by Said Method

(75) Inventors: Takayuki Homma, Tokyo (JP); Mikiko Saito, Tokyo (JP)

(73) Assignee: Waseda University, Tokyo (JP)

(21) Appl. No.: 13/536,397

(22) Filed: Jun. 28, 2012

Related U.S. Application Data
(63) Continuation-in-part of application No. PCT/JP2011/055539, filed on Mar. 9, 2011.

(30) Foreign Application Priority Data
Mar. 19, 2010 (JP) 2010-064194

(51) Int. Cl. C25D 1/10; B32B 3/30

(52) U.S. Cl. 428/172; 205/70

(57) ABSTRACT

There are provided a mold manufacture method capable of easily manufacturing a mold having a nanosized fine structure, and a mold obtained using such method. The mold manufacture method includes: a step of forming a self-assembled film 2 on an inorganic thin film 1 having the fine structure, the self-assembled film 2 being composed of a silane coupling agent having a functional group including at least one of an amino group, a mercapto group, a thiol group, a disulfide group, a cyano group, a halogen group and a sulfonic acid group; a conductive layer formation step of forming a conductive layer 3 on the self-assembled film 2; and a step of forming a metal film 4 on the conductive layer 3 through electroplating.

### CROSS-REFERENCE TO RELATED APPLICATIONS

The present application is a continuation-in-part application of International Application No. PCT/JP2011/055539, filed Mar. 9, 2011, which claims priority to Japanese Patent Application No. 2010-064194, filed Mar. 19, 2010. The contents of these applications are incorporated herein by reference in their entirety.

### BACKGROUND OF THE INVENTION

1. Field of the Invention

The present invention relates to a mold manufacture method and a mold formed using the method. Particularly, the present invention is suitable for use in a mold having a fine structure.

2. Discussion of the Background

A conventional mold manufacture method is shown in FIG. 12A through FIG. 12D. A resist is applied on a glass substrate or an Si substrate 100, followed by forming a pattern 101 on the resist with the aid of an ultraviolet ray, an electron beam, an X-ray or the like. A conductive layer 102 is then formed thereon through a sputtering method (e.g., Japanese Unexamined Patent Application Publication No. 2007-172712). Next, the conductive layer 102 is plated with Ni so as to form a metal film 103 thereon. A mold 104 is then obtained by demolding the metal film 103.

The aforementioned conventional method allows the plating to be embedded in holes without any difficulty, when employing a fine structure at a submicron level.

### SUMMARY OF THE INVENTION

In response to further densification and/or technical sophistication, an even finer nanosized fine structure or three-dimensional structure has been required, thus making it necessary to form an even finer pattern. However, the conventional method has imposed a problem of not being able to allow the plating to be embedded in the holes in such case.

Further, formation of a conductive layer in a three-dimensional structure has been difficult due to a lack of coverage, when the corresponding conductive layer is formed through a sputtering method.

Here, it is an object of the present invention to provide a mold manufacture method capable of easily manufacturing a mold having a nanosized structure, and a mold obtained using such method.

The invention according to a first aspect of the present invention is a mold manufacture method allowing a metal film to be formed on an inorganic thin film having a fine structure, and a mold to then be formed by separating the metal film from the inorganic thin film. The mold manufacture method includes: a step of forming on the inorganic thin film a self-assembled film containing a silane coupling agent having a functional group including at least one of an amino group, a mercapto group, a thiol group, a disulfide group, a cyano group, a halogen group and a sulfonic acid group; a conductive layer formation step of forming a conductive layer on the self-assembled film; and a step of forming the metal film on the conductive layer.

According to the invention as set forth in a second aspect of the present invention, the conductive layer formation step includes: a step of forming a metal ion layer on the self-assembled film; a step of reducing the metal ion layer by immersing the metal ion layer in a reducing solution; and a step of forming a thin-film plating layer on the metal ion layer.

According to the invention as set forth in a third aspect of the present invention, the metal ion layer is formed by immersing the self-assembled film formed on the inorganic thin film in a solution containing at least one of Au, Pd, Ag, Pt, Bi and Pb.

The invention according to a fourth aspect of the present invention is a mold obtained by forming a metal film on an inorganic thin film having a fine structure, and then separating the metal film from the inorganic thin film. The mold allows: a self-assembled film to be formed on the inorganic thin film; a conductive layer including a metal ion layer to be formed on the self-assembled film; and the metal film to be formed on the conductive layer through electroplating. Here, the self-assembled film contains a silane coupling agent having a functional group including at least one of an amino group, a mercapto group, a thiol group, a disulfide group, a cyano group, a halogen group and a sulfonic acid group.

According to the invention as set forth in a fifth aspect of the present invention, the conductive layer includes a thin-film plating layer formed on the metal ion layer through electroless Ni plating.

According to the invention as set forth in a sixth aspect of the present invention, the metal film is formed through Ni electroplating.

According to the invention as set forth in a seventh aspect of the present invention, the conductive layer and the inorganic thin film exhibit an adhesion of 0.3 mN to 50 mN therebetween, when measured with a probe having 5-μm radius tip.

The present invention allows a mold having a nanosized structure to be manufactured easily.

### BRIEF DESCRIPTION OF THE DRAWINGS

FIG. 1 is a cross-sectional view showing how a metal film is formed using a mold manufacture method of the present invention;

FIG. 2 is a diagram showing how a pattern is formed on an inorganic thin film, such diagram being a cross-sectional view depicting the mold manufacture method of the present invention in a stepwise manner;

FIG. 3 is a diagram showing how a self-assembled film is formed on the pattern, such diagram being a cross-sectional view depicting the mold manufacture method of the present invention in the stepwise manner;

FIG. 4 is a diagram showing how a conductive layer is formed on the self-assembled film, such diagram being a cross-sectional view depicting the mold manufacture method of the present invention in the stepwise manner;

FIG. 5 is a cross-sectional view of an adsorption model;

FIG. 6 is a diagram showing how the metal film is formed on the conductive layer, such diagram being a cross-sectional view depicting the mold manufacture method of the present invention in the stepwise manner;

FIG. 7 is a diagram showing a mold obtained through demolding, such diagram being a cross-sectional view depicting the mold manufacture method of the present invention in the stepwise manner;

FIG. 8A and FIG. 8B are electron micrographs showing a result of a working example 1 of the present invention, in which FIG. 8A shows a surface of an Si oxide film after removing the conductive layer, and FIG. 8B shows a surface of the mold separated from the surface of the Si oxide film;

FIG. 9 is a diagram showing a schematic configuration of a measurement device used to measure an adhesion in a working example 2 of the present invention;

FIG. 10 is a diagram schematically showing how the metal film is separated from the inorganic thin film as a result of being pressed against by a probe in the working example 2;

FIG. 11 is a diagram showing a result of the working example 2, i.e., a graph showing a relationship between a thickness of the conductive layer and the adhesion;

FIG. 12A through FIG. 12D are cross-sectional views showing a conventional mold manufacture method in a stepwise manner, in which FIG. 12A shows how a pattern is formed on a substrate, FIG. 12B shows how a conductive layer is formed on the pattern, FIG. 12C shows a state where a Ni plating layer is formed, and FIG. 12D shows the Ni plating layer removed through demolding.

### DESCRIPTION OF THE EMBODIMENTS

An embodiment of the present invention is described in detail hereunder, with reference to the accompanying drawings.

### (Manufacture Method)

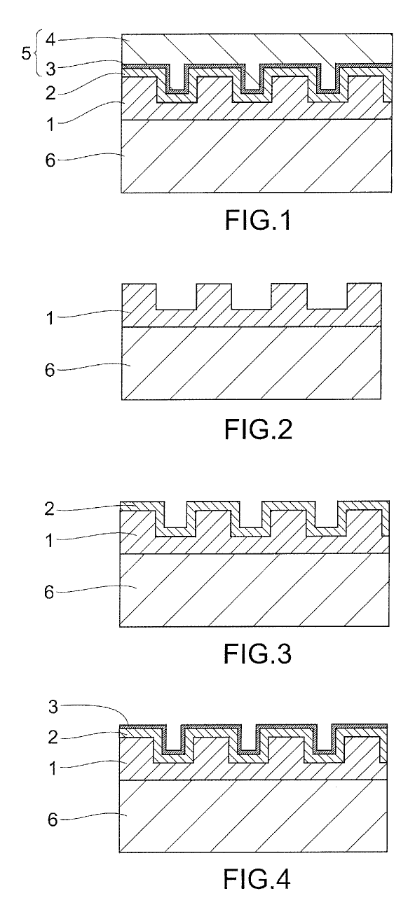

As shown in FIG. 1, a mold manufacture method of the present invention allows a self-assembled monolayer (SAM) 2 (referred to as “self-assembled film” hereunder) to be formed on an inorganic thin film 1 having a nanosized fine pattern. Accordingly, a conductive layer 3 can then be uniformly formed on the corresponding pattern, thereby allowing a metal film 4 to be formed thereon with a plating embedded more reliably in the pattern, thus making it possible to easily manufacture a mold 5 having a nanosized fine structure. In this case, the conductive layer 3 serves as an electrode for electroplating through which the metal film 4 is formed.

As shown in FIG. 2, the nanosized pattern is at first formed on the inorganic thin film 1 in the mold manufacture method. In the present embodiment, the pattern is a concavo-convex two-dimensional structure. A method for forming the pattern is not limited to a specific method. In fact, there can be used a technique heretofore known. According to the present embodiment, the inorganic thin film 1 is made of an Si oxide film formed on a surface of an Si substrate 6. A resist is applied on the inorganic thin film 1, followed by allowing a given pattern on such inorganic thin film 1 to be exposed to an ultraviolet ray, an electron beam, an X-ray or the like with the aid of a mask. The aforementioned nanosized pattern is then obtained through dry etching.

Next, as shown in FIG. 3, the mold manufacture method allows the self-assembled film 2 to be grown on the inorganic thin film 1. The self-assembled film 2 is composed of a monolayer made of a silane coupling agent having a functional group including at least one of an amino group, a mercapto group, a thiol group, a disulfide group, a cyano group, a halogen group and a sulfonic acid group.

Using a first solution containing the aforementioned silane coupling agent, the self-assembled film 2 is to be formed on a surface of the inorganic thin film 1 by being chemically adsorbed thereon through either liquid phase growth or vapor phase growth. Liquid phase growth allows the self-assembled film 2 to be formed by immersing in the first solution the Si substrate 6 with the inorganic thin film 1 formed thereon. Instead, vapor phase growth allows the self-assembled film 2 to be formed by exposing the inorganic thin film 1 formed on the Si substrate 6 to a vapor obtained by evaporating the first solution.

The first solution can, for example, be a solution prepared by heating a toluene solution containing 3-aminopropyltrimethoxysilane (APTMS) by 10% to a temperature of 60° C., such 3-aminopropyltrimethoxysilane (APTMS) being a silane coupling agent and shown in Formula 1. The self-assembled film 2 has an other terminal functional group on the opposite side of a functional group chemically adsorbed on the surface of the inorganic thin film 1. The self-assembled film 2 has molecular distances thereof determined by Van der Waals' forces.

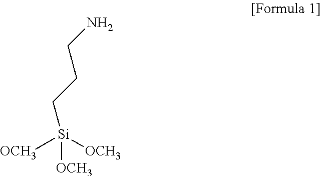

Further, as a silane coupling agent, there can be used mercaptopropyltrimethoxysilane (MPTMS) shown in Formula 2, 3-[2-(2-aminoethylamino)ethylamino]propyltrimethoxysilane (TAS) shown in Formula 3, or the like.

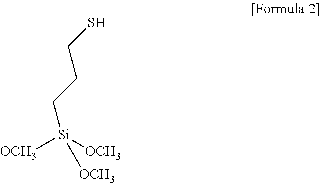

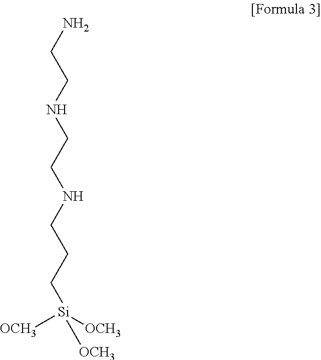

Next, as shown in FIG. 4, the mold manufacture method allows the conductive layer 3 to be formed on the self-assembled film 2. Although not shown in the drawings, the conductive layer 3 includes a metal ion layer formed on the self-assembled film 2 and a thin-film plating layer formed on the corresponding metal ion layer. The metal ion layer is formed by immersing the self-assembled film 2 formed on the inorganic thin film 1 in a second solution containing at least one of Au, Pd, Ag, Pt, Bi and Pb. In this case, metal ion(s) contained in the second solution are chemically adsorbed to the terminal functional group of the self-assembled film 2. As a solvent of the second solution, there can be used, for example, a dilute hydrochloric acid, a dilute nitric acid, a dilute sulfuric acid or the like.

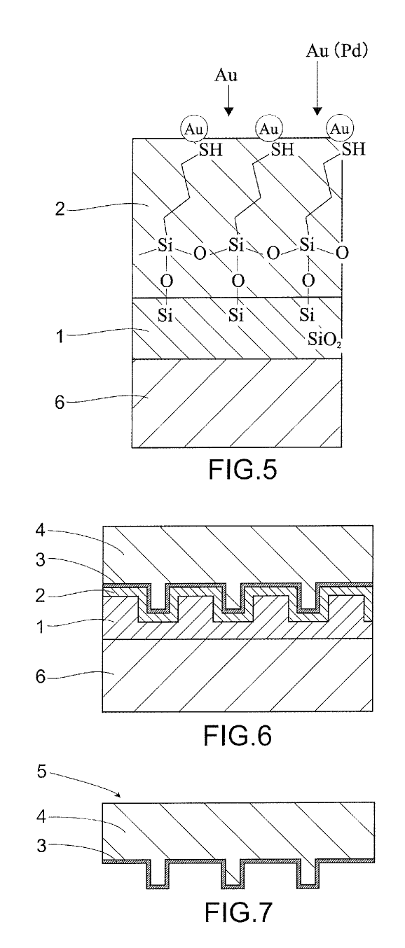

For example, when using mercaptopropyltrimethoxysilane (MPTMS) as a silane coupling agent, the self-assembled film 2 will be formed in a manner shown in FIG. 5. That is, the self-assembled film 2 will be formed through silane coupling reaction on a surface of the Si oxide film serving as the inorganic thin film 1. Further, the metal ion layer will be formed on a surface of the self-assembled film 2 as the metal ion(s) (Au⁺ in FIG. 5) are adsorbed thereon.

With the metal ion layer thus formed being a core, the thin-film plating layer is then formed through electroless plating with the aid of a weakly acidic plating bath. The thin-film plating layer can employ various kinds of metals. For example, the thin-film plating layer can be formed of Ni, Co, Pt, Sn, Au, Cu or the like.

Here, it is more preferable in terms of reliably forming the thin-film plating layer, that a surface of the metal ion layer be immersed in a reducing solution after forming the corresponding metal ion layer and before forming the thin-film plating layer so as to reduce the metal ion layer that is oxidized.

Next, as shown in FIG. 6, the mold manufacture method allows the metal film 4 to be formed on the conductive layer 3 through electroplating. This metal film 4 can be formed through a technique heretofore known. For example, the metal film 4 can be formed through Ni electroplating.

In the end, as shown in FIG. 7, the mold manufacture method allows the conductive layer 3 to be separated from the inorganic thin film 1, thereby obtaining the mold 5 composed of the conductive layer 3 and the metal film 4. Here, it is preferred that an adhesion between the inorganic thin film 1 and the conductive layer 3 be not smaller than 0.3 mN and not larger than 50 mN when measured with a probe having 5-μm radius tip. An adhesion of less than 0.3 mN causes partial peeling-off to occur during a manufacture process such as the formation of the conductive layer, which leads to failures. Meanwhile, an adhesion of larger than 50 mN makes demolding difficult and may cause damages on the metal film, which also leads to failures.

### (Function and Effect)

According to the mold manufacture method of the present invention, the self-assembled film 2 composed of the silane coupling agent is to be formed on the inorganic thin film 1 having the nanosized pattern, thereby allowing the conductive layer 3 to be uniformly formed on the corresponding pattern. Thus, with the conductive layer 3 serving as an electrode, the plating is allowed to be embedded more reliably in the nanosized pattern through electroplating, thereby making it possible to easily manufacture the mold having the nanosized fine structure.

Further, the conductive layer 3 includes the metal ion layer and the thin-film plating layer, thus more reliably forming the electrode needed when forming the metal film 4 through electroplating.

With regard to a chemical adsorption of the metal ion layer on the self-assembled film 2, the adsorption reaction ceases as the metal ion(s) have been adsorbed to all the terminal functional groups of the self-assembled film 2, thus stopping the growth of the metal ion layer. Therefore, although it is normally preferred that a thin-film plating be formed on the metal ion layer in order to ensure a thickness required for the electroplated electrode, the conductive layer 3 may omit the thin-film plating layer therefrom and be composed of only the metal ion layer if the metal ion layer can be grown to the thickness required for the electroplated electrode.

Working examples are described hereunder.

### Working Example 1

In the beginning, a nanosized pattern was formed on an Si oxide film formed on an Si substrate and serving as an inorganic thin film. A 1-inch wafer was used as the Si substrate. Further, a size of the pattern formed was 200 nm in diameter.

Next, a self-assembled film was formed on the aforementioned pattern through liquid phase growth. In the present working example, the self-assembled film was formed by immersing the patterned Si oxide film in a first solution for 10 minutes, such first solution being prepared by heating a toluene solution containing a silane coupling agent by 1 wt. % to a temperature of 60° C. As a silane coupling agent, there was used 3-[2-(2-aminoethylamino)ethylamino] propyltrimethoxysilane (TAS).

Next, as a conductive layer, there were successively formed a metal ion layer and a thin-film plating layer. The metal ion layer was formed by immersing the Si substrate with the self-assembled film formed thereon in a second solution containing Pd for one minute. As a solvent, there was used a dilute hydrochloric acid. Here, a Pd concentration in the second solution was 1 mM.

The thin-film plating layer was formed through electroless Ni plating in which the Si substrate with the metal ion layer formed thereon was immersed in an electroless Ni plating bath shown in Table 1 for five minutes.

TABLE 1

| CHEMICAL | CONCENTRATION |
|---|---|
| SUBSTANCE | (mol/dm³) |
| CH₃COONH₄ | 0.4 |
| NiSO₄•6H₂O | 0.1 |
| NaH₂PO₂•H₂O | 0.2 |
| pH | 5.5 |
| TEMPERATURE | 55° C. |

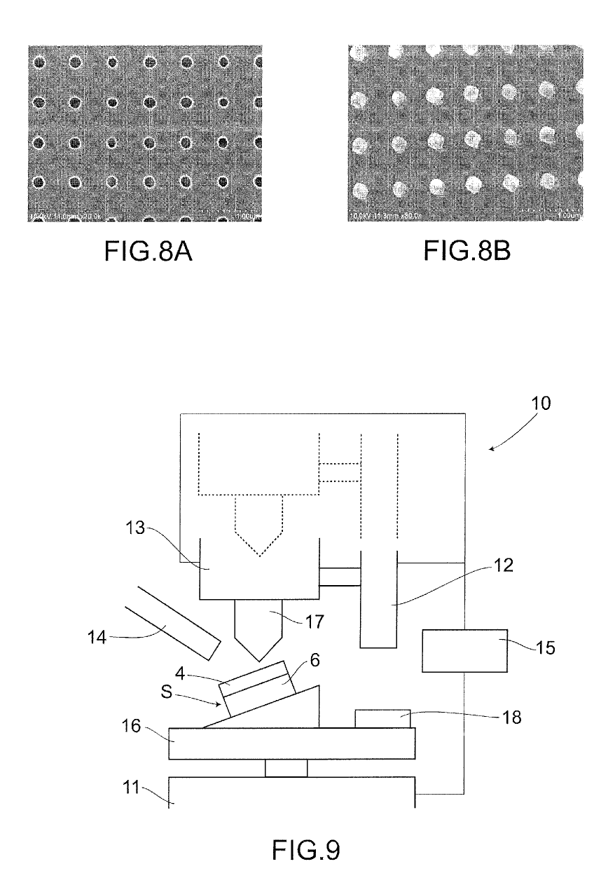

The Si substrate with such conductive layer formed thereon, was further immersed in an Ni electroplating bath and had the corresponding conductive layer electrified, thereby forming a metal film of a thickness of about 300 μm. Next, a mold was obtained by separating the conductive layer from the Si oxide film. A result thereof is shown in FIG. 8A and FIG. 8B. As shown in FIG. 8B, it was confirmed that a nanosized fine structure could be recreated in the mold by using a mold manufacture method of the present working example.

Further, it was confirmed that the metal film could be similarly formed even when using 3-aminopropyltrimethoxysilane (APTMS) or mercaptopropyltrimethoxysilane (MPTMS) as a silane coupling agent.

In this way, according to the mold manufacture method of the present invention, it was confirmed that the mold having the nanosized fine structure could be manufactured by forming the conductive layer on the self-assembled film composed of a silane coupling agent.

### Working Example 2

Next, there was confirmed an adhesion between the inorganic thin film and the conductive layer. 3-[2-(2-aminoethylamino)ethylamino]propyltrimethoxysilane (TAS) was used as a silane coupling agent to form the self-assembled film on the Si substrate, followed by forming the metal ion layer of Pd on the corresponding self-assembled film and further forming an electroless sample on the corresponding metal ion layer. As a comparative example, there was formed an Sn—Pd-treated Si substrate.

A measurement device 10 shown in FIG. 9 was used to measure the adhesion. The measurement device 10 included an electronic digital scale 11, a displacement gage 12, a piezo actuator 13, a microscope 14 and an electronic computer 15.

A sample tray 16 was provided on the electronic digital scale 11. The sample tray 16 was so configured that a sample S could be held thereby at a given slanting angle. Here, the given angle in the present working example was set to be 30 degrees.

The piezo actuator 13 was integrally provided with the displacement gage 12, and was provided with a probe (having 5-μm radius tip) 17 for abutting against a metal film 4 formed on the sample S. The displacement gage 12 was of a non-contact type, and was so configured that it could measure a depth to which the probe 17 pushes, by irradiating a mirror 18 provided on the sample tray 16 with a light and then detecting a change in a strength of a reflected light of the corresponding light. The microscope 14 was so configured that it could be used to observe a surface of the sample S placed in the sample tray 16.

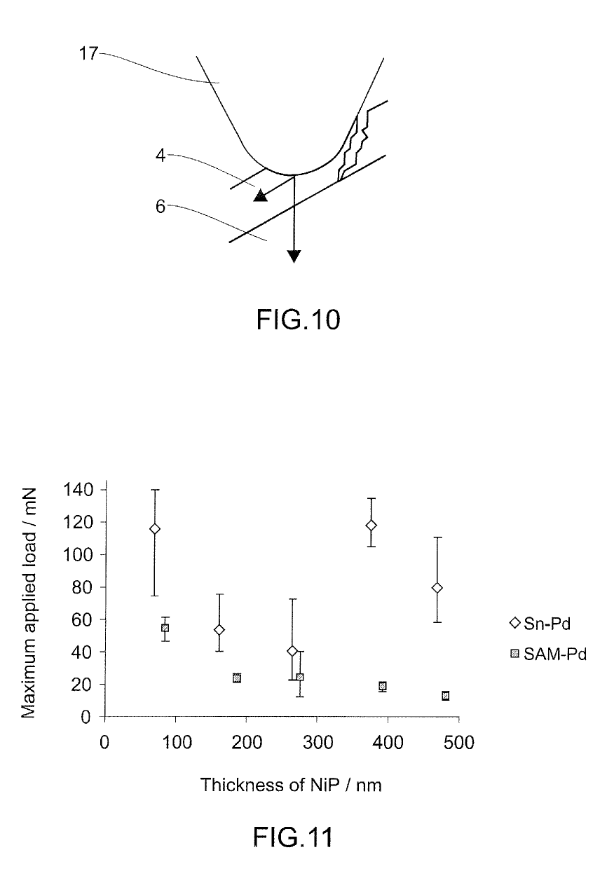

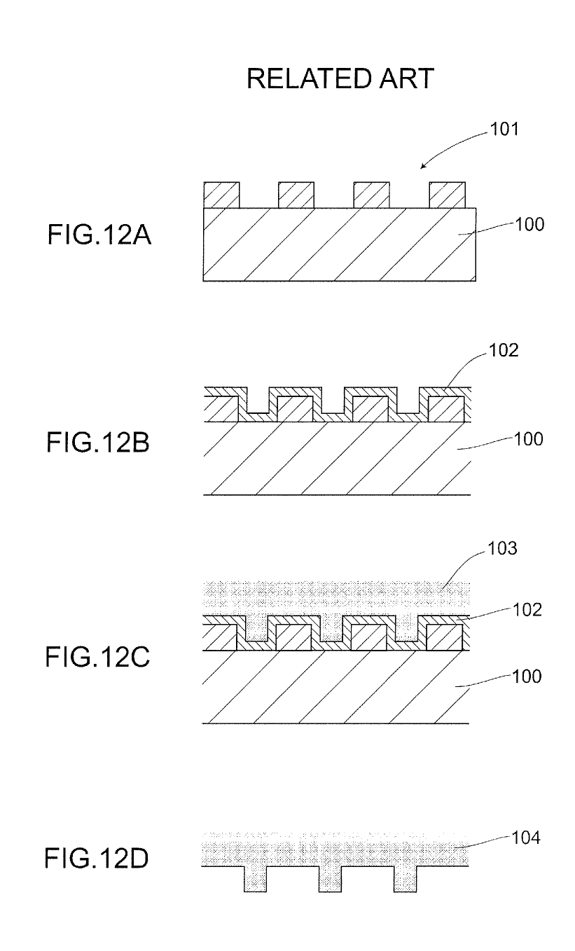

The measurement device 10 thus configured allowed the piezo actuator 13 to be moved toward the sample tray 16 so as to allow the probe (having 5-μm radius tip) 17 to be pressed against the metal film 4. A moving speed of the piezo actuator 13 was set to be 10 nm/s in this case. A load applied to the metal film 4 by the probe 17 was measured by means of the electronic digital scale 11. A point at which an extreme decrease in the aforementioned load was observed, was considered as when the conductive layer had been separated from the inorganic thin film (FIG. 10), and the load measured at such point was defined as the adhesion. A result thereof is shown in FIG. 11. As shown in FIG. 11, it was confirmed that the adhesion between the conductive layer and the Si oxide film (“SAM-Pd” in FIG. 11) was within a range of 0.3 mN to 50 mN, regardless of a thickness of the thin-film plating layer. In this way, according to the mold manufacture method of the present invention, it was confirmed that the adhesion at the time of demolding was dependent on a combination of the inorganic thin film and the silane coupling agent composing the self-assembled film.

Meanwhile, since the comparative example (“Sn—Pd” in FIG. 11) was obtained through metallic bond, it was confirmed that an adhesion thereof was larger than that of the present working example, and that a variation in the corresponding adhesion was also larger than that of the present working example. As described above, the mold manufacture method of the present invention allows a desired adhesion to be achieved by selectively employing a silane coupling agent.

### Modified Example

The present invention is not limited to the aforementioned working examples. In fact, proper modifications are possible within the scope of the gist of the present invention. For example, according to the mold manufacture method described in the aforementioned working examples, the molds manufactured had two-dimensional structures that were concavo-convex. However, the present invention is not limited to such configuration. As a matter of fact, since the self-assembled film can be uniformly formed also on a pattern of a three-dimensional structure, there can be similarly manufactured a mold with a three-dimensional structure.

According to the descriptions of the aforementioned working examples, the self-assembled film was formed through liquid phase growth. However, the present invention is not limited to such case. In fact, the self-assembled film may be formed through vapor phase growth.

What is claimed:

1. A mold manufacture method allowing a metal film to be formed on an inorganic thin film having a fine structure, and a mold to then be formed by separating said metal film from said inorganic thin film, comprising:
a step of forming on said inorganic thin film a self-assembled film containing a silane coupling agent having a functional group including at least one of an amino group, a mercapto group, a thiol group, a disulfide group, a cyano group, a halogen group and a sulfonic acid group;
a conductive layer formation step of forming a conductive layer on said self-assembled film; and
a step of forming said metal film on said conductive layer.

2. The mold manufacture method according to claim 1, wherein said conductive layer formation step comprises:
a step of forming a metal ion layer on said self-assembled film;
a step of reducing said metal ion layer by immersing said metal ion layer in a reducing solution; and
a step of forming a thin-film plating layer on said metal ion layer.

3. The mold manufacture method according to claim 2, wherein said metal ion layer is formed by immersing said self-assembled film formed on said inorganic thin film in a solution containing at least one of Au, Pd, Ag, Pt, Bi and Pb.

4. A mold obtained by forming a metal film on an inorganic thin film having a fine structure, and then separating said metal film from said inorganic thin film, allowing:
a self-assembled film to be formed on said inorganic thin film;
a conductive layer including a metal ion layer to be formed on said self-assembled film; and
said metal film to be formed on said conductive layer through electroplating, wherein said self-assembled film contains a silane coupling agent having a functional group including at least one of an amino group, a mercapto group, a thiol group, a disulfide group, a cyano group, a halogen group and a sulfonic acid group.

5. The mold according to claim 4, wherein said conductive layer includes a thin-film plating layer formed on said metal ion layer through electroless Ni plating.

6. The mold according to claim 4, wherein said metal film is formed through Ni electroplating.

7. The mold according to claim 4, wherein said conductive layer and said inorganic thin film exhibit an adhesion of 0.3 mN to 50 mN therebetween, when measured with a probe having 5-μm radius tip.

8. The mold according to claim 6, wherein said conductive layer and said inorganic thin film exhibit an adhesion of 0.3 mN to 50 mN therebetween, when measured with a probe having 5-μm radius tip.

9. The mold according to claim 5, wherein said metal film is formed through Ni electroplating.

10. The mold according to claim 5, wherein said conductive layer and said inorganic thin film exhibit an adhesion of 0.3 mN to 50 mN therebetween, when measured with a probe having 5-μm radius tip.
